(19) United States
(12) Patent Application Publication
(10) Pub. No.: US 2013/0098748 A1
(43) Pub. Date: Apr. 25, 2013

(54) MULTI-WAY BUTTON STRUCTURE

(71) Applicant: TSUNG-SHIH LEE, New Taipei (TW)

(72) Inventor: TSUNG-SHIH LEE, New Taipei (TW)

(73) Assignee: Cheng Uei Precision Industry Co., LTD., New Taipei City (TW)

(21) Appl. No.: 13/279,233

(22) Filed: Oct. 21, 2011

(51) Int. Cl. H01H 21/02

(52) U.S. Cl. 200/6 R

(57) ABSTRACT

A multi-way button structure is disclosed. The multi-way button structure includes a multi-way switch, a knob, and an operating stick. The multi-way switch is welded on a circuit board and includes an operating stick. A stick inserting hole is defined in the center of the bottom of the knob. The stick inserting hole is used for the operating stick inserted therein for assembling the knob with the multi-way switch. Plural elastic elements surround the multi-way switch and are disposed between the circuit board and the knob. By disposing the elastic elements between the circuit board and the knob, when the knob is pressed, a pivot to which bearing force is applied is positioned on the elastic elements. Accordingly, the design width of the knob is not limited by the width of the multi-way switch, thereby increasing the design flexibility, the durability, and the bearing force of the knob.

### BACKGROUND OF THE INVENTION

1. Field of the Invention

The present invention generally relates to a mechanism, and more particularly to a new design for a multi-way button structure.

2. Description of Prior Art

A hand-held electronic product often has a multi-way button, which comprises a multi-way switch and a knob assembled on the multi-way switch. When a user presses the up side, down side, left side, right side, or center of the top surface of the knob, the multi-switch generates a signal corresponding to the up side, down side, left side, right side, or center of the top surface of the knob. The signal is inputted to the hand-held electronic product, and a display of the hand-held electronic product displays an action corresponding to the signal.

With rapid development of technology, the hand-held electronic product tends to be slim and compact and a size of the multi-way switch is designed to be small. Accordingly, a length of an operating stick of the multi-way switch is so short that a design width of the knob is limited. The limited design width of the knob is inconvenience when the user uses the multi-way button.

FIG. 1 is a schematic diagram showing a conventional multi-way button structure. The multi-way button structure comprises a multi-way switch 10′ which is welded on a circuit board 200′. The multi-way switch 10′ comprises an operating stick 11′, and a stick inserting hole 21′ corresponding to the operating stick 11′ is defined in the center of the bottom of the knob 20′. The operating stick 11′ is inserted in the stick inserting hole 21′ for assembling the knob 20′ with the multi-way switch 10′, thereby forming the multi-way button structure 100. In general situations, the design width of the knob 20′ is not to greater than the width of the multi-way switch 10′.

According to the above-mentioned multi-way button structure, when a finger of the user presses the up side, down side, left side, or right side of the top surface of the knob 20′, a pivot, to which bearing force is applied, is positioned in the lateral of the operating stick 11′. If the design width of the knob is greater than the width of multi-way switch 10′, a straight-line distance of a position, of which a point of application of force is positioned, will be greater than a distance between the knob 20′ and the multi-way switch 10′ in the stick inserting hole 21′. Accordingly, the force from the finger of the user causes the knob 20′ to be separated from the multi-way switch 10′.

### SUMMARY OF THE INVENTION

To solve the above-mentioned deficiencies in the prior arts, an objective of the present invention is to provide a multi-way button structure, thereby solving the problem that the width of the knob is limited by the width of the multi-way switch in the prior arts.

To implement the above-mentioned objective, the multi-way button structure in accordance with to an aspect of the present invention comprises a multi-way switch, a knob, and an operating stick. The multi-way switch is welded on a circuit board and comprises an operating stick. A stick inserting hole corresponding to the operating stick is defined in the center of the bottom of the knob. The operating stick of the multi-way switch is inserted in the stick inserting hole for assembling the knob with the multi-way switch. An up directional sign, a down directional sign, a left directional sign, and a right directional sign can be formed on the top surface of the knob as required. Plural elastic elements surround the multi-way switch and are disposed between the circuit board and the knob. One end of each of the elastic elements is fixed to the bottom of the knob.

As mentioned above, the multi-way button structure in accordance with the present invention comprises the elastic elements disposed between the circuit board and the knob. When a finger of a user presses one of the up, down, left, and right directional signs on the knob, a pivot to which bearing force is applied is positioned on a contact face between the knob and the elastic elements. More particularly, the pivot to which bearing force is applied in the present invention is different from that in the prior arts. As a result, the design width of the knob is not limited by the width of the multi-way switch, thereby increasing the design flexibility, the durability, and the bearing force of the knob.

### BRIEF DESCRIPTION OF THE DRAWINGS

FIG. 1 is a sectional view of a conventional multi-way button structure.

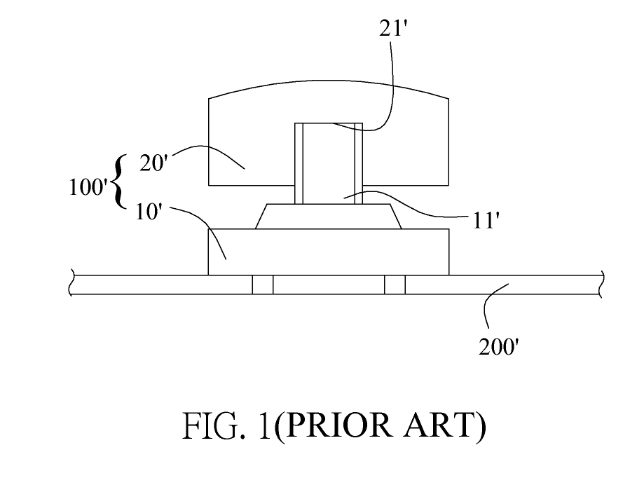

FIG. 2 is a sectional view of a multi-way button structure in accordance with an embodiment of the present invention.

FIG. 3 is a top view of the multi-way button structure in FIG. 2.

### DETAILED DESCRIPTION OF THE INVENTION

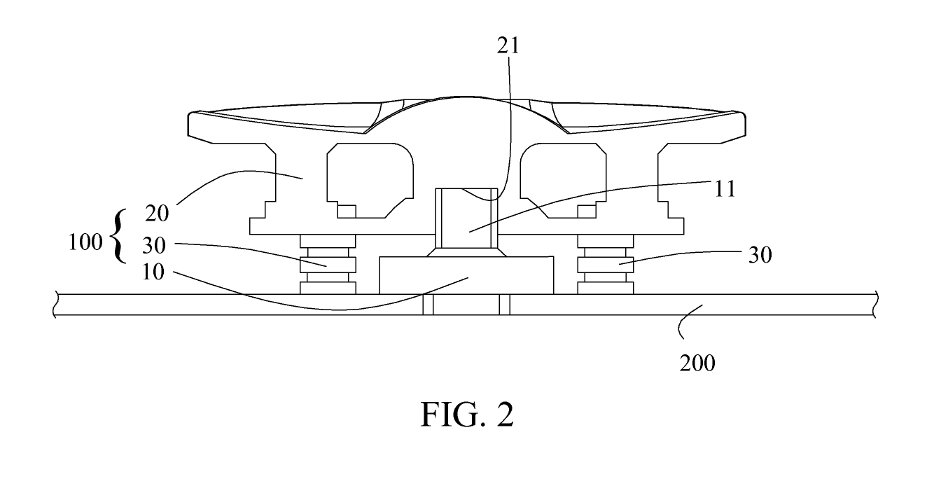

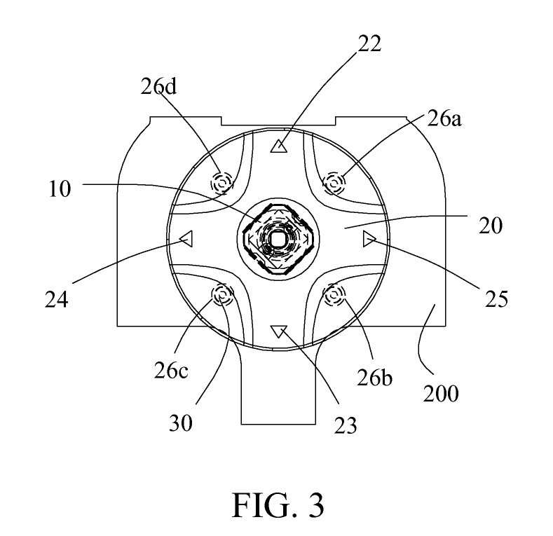

Please refer to FIGS. 2 and 3, a multi-way button structure 100 in accordance with an embodiment of the present invention comprises a multi-way switch 10, a knob 20, and a plurality of elastic elements 30. The bottom of the multi-way switch 10 in the present embodiment is welded on a circuit board 200. An operating stick 11 protrudes from the center of the top of the multi-way switch 10, while a stick inserting hole 21 corresponding to the operating stick 11 is defined in the center of the bottom of the multi-way switch 10. The operating stick 11 is inserted in the stick inserting hole 11 for assembling the knob 20 with the multi-way switch 10.

An up directional sign 22, a down directional sign 23, a left directional sign 24, and a right directional sign 25 can be formed on the top surface of the knob 20 as required. Preferredly, disposal positions of the elastic elements 30 are determined according to the elastic modulus of the elastic elements 30 and/or positions of the directional signs. In the present embodiment, the multi-way switch 10 is a five-way switch. The multi-way button structure 100 comprises four elastic elements 30. The elastic elements 30 surround the multi-way switch 10 and are disposed between the circuit board 200 and the knob 20 (as shown in FIG. 2). One end of each of the elastic elements 30 is fixed to the bottom of the knob 20. As mentioned above, since the multi-way switch 10 is a five-way switch in the present embodiment, the disposal positions of the four elastic elements 30 are respectively corresponding to the positions between two adjacent directional signs on the knob 20. That is, the disposal positions of the four elastic elements 30 are respectively corresponding to the position 26a between the up directional sign 22 and the right directional sign 25, the position 26b between the right directional sign 25 and the down directional sign 23, the position 26c between the down directional sign 23 and the left directional sign 24, and the position 26d between the left directional sign 24 and the up directional sign 22 as shown in FIG. 3. It is noted that the present embodiment utilizes four elastic elements 30, other amounts of the elastic elements 30 can be implemented as required.

The elastic elements 30 are made of suitable material, for example, one material selected from a group consisting of spring, rubber, and polyurethane.

As mentioned above, the multi-way button structure 100 in accordance with the present invention comprises the elastic elements 30 disposed between the circuit board 200 and the knob 20. When a finger of a user presses one of the up, down, left, and right directional signs 22, 23, 24, 25 on the knob 20, a pivot to which bearing force is applied is positioned on a contact face between the knob 20 and the elastic elements 30. More particularly, the pivot to which bearing force is applied in the present invention is different from that in the prior arts. As a result, the design width of the knob 20 is not limited by the width of the multi-way switch 10, thereby increasing the design flexibility, the durability, and the bearing force of the knob 20.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A multi-way button structure, comprising:
a multi-way switch, welded on a circuit board and comprising an operating stick;
a knob, wherein a stick inserting hole corresponding to the operating stick is defined in the center of the bottom of the knob, and the stick inserting hole is used for the operating stick of the multi-way switch inserted therein for assembling the knob with the multi-way switch; and
a plurality of elastic elements, surrounding the multi-way switch and disposed between the circuit board and the knob.

2. The multi-way button structure as claimed in claim 1, wherein the elastic elements are made of one material selected from a group consisting of spring, rubber, and polyurethane.

3. The multi-way button structure as claimed in claim 1, wherein one end of each of the elastic elements is fixed to the bottom of the knob.

4. The multi-way button structure as claimed in claim 1, wherein plural directional signs are formed on a top surface of the knob.

5. The multi-way button structure as claimed in claim 4, wherein disposal positions of the elastic elements are determined according to positions of the directional signs.

6. The multi-way button structure as claimed in claim 5, wherein the disposal positions of the elastic elements are respectively corresponding to positions between two adjacent directional signs.

7. The multi-way button structure as claimed in claim 1, wherein disposal positions of the elastic elements are determined according to elastic modulus of the elastic elements.
